(19) United States
(12) Patent Application Publication
(10) Pub. No.: US 2011/0222700 A1
(43) Pub. Date: Sep. 15, 2011

(54) ADAPTIVE ACTIVE NOISE CANCELLATION SYSTEM

(76) Inventor: Sanjay Bhandari, San Jose, CA (US)

(21) Appl. No.: 13/046,358

(22) Filed: Mar. 11, 2011

Related U.S. Application Data
(60) Provisional application No. 61/314,128, filed on Mar. 15, 2010.

(51) Int. Cl. G10K 11/16

(52) U.S. Cl. 381/71.6; 381/71.1; 381/71.8

(57) ABSTRACT

A system includes a noise detector configured to identify undesirable noise components in an acoustic signal and a noise energy profiler configured to analyze the identified undesirable noise components and generate a noise energy profile. In the system, a cancelation profile generator is configured to generate a noise cancelation profile based at least in part on information in the noise energy profile, and a cancelation profile effector is configured to translate the noise cancelation profile into values for a programmable circuit.

### CROSS REFERENCE TO RELATED APPLICATIONS

The present application claims benefit to U.S. provisional application 61/314,128 filed Mar. 15, 2010, the contents of which is incorporated herein in its entirety.

### BACKGROUND

Signals propagating through electrical systems may include desirable signal components and undesirable signal components. An undesirable component may be generated outside of an electrical system or generated by the electrical system itself. In an acoustic system, one such undesirable component is ambient acoustic noise.

Circuits are often incorporated into an acoustic system to actively cancel certain types of expected ambient acoustic noise. However, the actual ambient acoustic noise may be quite different than the expected ambient acoustic noise.

Thus, it is would be beneficial to have the ability to detect the actual ambient acoustic noise and adaptively configure the acoustic system to cancel the detected noise.

### FIGURES

FIG. 1 illustrates an exemplary system for processing signals within an electrical system.

FIG. 2 illustrates a first representative exemplary system for processing signals within an electrical system.

FIG. 3 illustrates an exemplary system model for a headphone with feedback.

FIG. 4 illustrates a second representative exemplary system for processing signals within an electrical system.

FIG. 5 illustrates a third representative exemplary system for processing signals within an electrical system.

FIG. 6 illustrates an exemplary process that may be implemented to identify ambient acoustic noise and adjust programmable circuits to cancel the noise at least in part.

### DETAILED DESCRIPTION

An exemplary acoustic system is an acoustic headphone in which it may be beneficial to cancel acoustic noise present in the ambient environment.

Some headphones are tuned at manufacture to cancel noise in certain frequency bands. For example, some headphones are tuned to cancel airplane engine noise that appears predominantly in the frequency band 200-300 Hertz (Hz). When such headphones are worn in an airplane the engine noise predominant in the ambient acoustic noise that penetrates the headphone ear cup is canceled within the headphone. When such headphones are worn elsewhere, the frequency band 200-300 Hz will still be canceled, but ambient acoustic noise at other frequencies may not be and the wearer of the headphone may hear ambient acoustic noise that penetrates the headphone ear cup.

Some headphones include a mechanism by which the wearer of the headphone may switch between generally two or three different cancelation options. For example, the wearer may switch between airplane, car, and train noise cancelation options. The wearer of such a headphone does not have the ability to cancel other ambient noise such as the noise of jackhammers, the noise of crying babies, and the noise of squeaky machinery, to name just a few. The wearer of the headphone would only have the ability to try the different available cancelation options. The number of options provided may be limited by the size of the switching mechanism or by perceived complexity of use.

A headphone as described below dynamically analyses the ambient acoustic noise and adaptively configures the headphone to cancel noise in at least a dominant frequency band of the noise. Analysis of noise may include determining the frequency band of the dominant potion of the noise. Analysis of noise may alternatively or additionally include profiling the energy of the noise by determining the energy of the noise at different frequencies or within different frequency bands.

Cancelation may be performed passively or actively. In passive cancelation, only acoustical noise cancellation is used. In active cancelation, an anti-noise signal is generated and combined with the electrical signal applied to the speaker within the headphone, or an anti-noise acoustic signal is produced through a secondary speaker within the headphone. Anti-noise is a signal equal in magnitude and opposite in phase to the noise to be canceled. The use of anti-noise is sometimes referred to as active noise cancellation. Active noise cancellation may include some combination of feedback and feed forward signal processing.

The term headphone as used herein may represent one headphone in a pair of headphones, one headphone in a headset with a single headphone, an earbud, an auditory aid, or any other acoustic device for transmitting audio signals from an input to a speaker. Further, the concepts described herein for headphones apply to other acoustic systems as well.

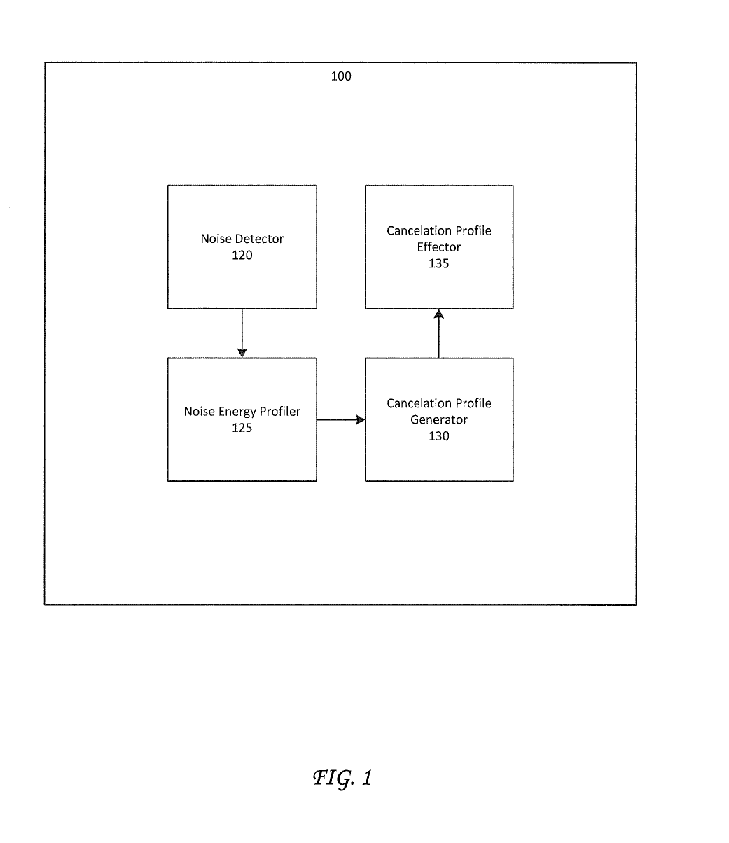

FIG. 1 illustrates an exemplary system 100 for adaptively canceling undesirable ambient noise.

System 100 may include a noise detector 120, a noise energy profiler 125, a cancelation profile generator 130, and a cancelation profile effector 135. The various elements of system 100 shown in FIG. 1 are presented as illustrative and not limiting. FIG. 1 may include more or fewer elements than shown as appropriate for a particular implementation.

Noise detector 120 may be any of or a combination of hardware, software, and firmware that performs the function of identifying noise in a system. Information regarding the identified noise is provided to the noise energy profiler 125. For example, information may include an analog or digital representation of the identified noise.

Noise energy profiler 125 may be any of or a combination of hardware, software, and firmware that performs the function of profiling the energy in the noise. Noise energy profiler 125 uses the information from noise detector 120 to create a profile of the noise. For example, the noise energy profile may include average amplitude of the noise for multiple frequencies or frequency bands. As another example, the noise energy profile may identify a frequency band of the noise that contains the most energy. Noise energy profiler 125 may provide the profile to cancelation profile generator 130.

Cancelation profile generator 130 may be any of or a combination of hardware, software, and firmware that performs the function of generating a profile for canceling noise.

In some implementations, cancelation profile generator 130 generates a profile that represents a desired transfer function for system 100 inherently including noise cancelation. In other implementations, cancelation profile generator 130 generates a profile that represents a desired anti-noise signal.

In some implementations, a noise cancelation profile may be as simple as a single amplification factor. In other implementations, a noise cancelation profile may be a complex set of equations, or may include, for example, a matrix or other set of frequency, amplitude, and phase information describing an anti-noise signal or a desired frequency response. A profile may further be an indicator of a selection of a stored profile. Some exemplary representative implementations of cancelation profile generator 130 and profiles are described in detail below. Cancelation profile generator 130 provides the generated profile to the cancelation profile effector 135.

Cancelation profile effector 135 may be any of or a combination of hardware, software, and firmware that performs the function of applying the anti-noise profile within the electrical system. The implementation of effector 135 is dependent on the architecture of system 100 and the form of the generated anti-noise profile. Thus, specific implementations of effector 135 are described in detail below with respect the associated exemplary implementations of cancelation profile generator 130.

Noise detector 120, noise energy profiler 125, cancelation profile generator 130, and cancelation profile effector 135 may be included in one or more computing devices. Examples of computing devices include, without limitation, a computer workstation, a server, a desktop, notebook, laptop, or handheld computer, a smart phone, a headphone, a device with an embedded processor, or some other known computing system or device.

Computing devices generally include computer-executable instructions. In general, a computing device receives instructions, e.g., from a memory, a computer-readable medium, etc., and executes these instructions, thereby performing one or more processes. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Such instructions may be transmitted by one or more transmission media.

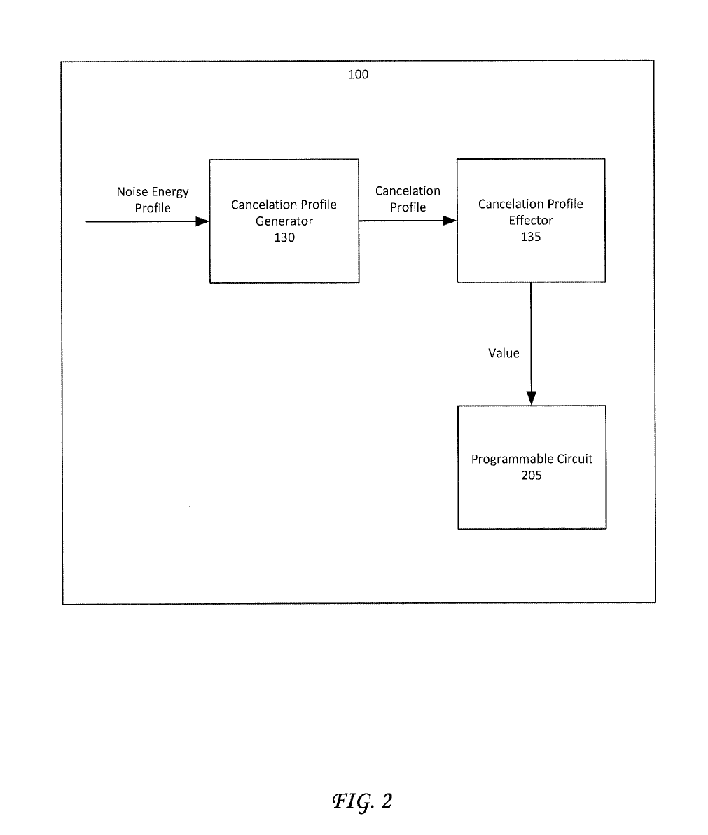

FIG. 2 illustrates a first representative exemplary cancelation profile generator 130 and associated cancelation profile effector 135, along with a programmable circuit 205. In this exemplary implementation, cancelation profile generator 130 analyzes the noise energy profile and provides one or more parameters representing the energy of the noise to cancelation profile effector 135. Effector 135 translates the one or more parameters into a register setting for programmable circuit 205 to adjust a gain or a transfer function of the programmable circuit such that an anti-noise signal generated by the programmable circuit largely cancels the ambient noise. For example, if a headphone was tuned at manufacture to cancel a certain expected magnitude of airplane noise but the actual airplane noise was significantly louder, an error amplifier in a feedback loop could be programmed for higher gain to cause a higher-magnitude anti-noise signal to be generated.

In other implementations, cancelation profile effector 135 may translate the one or more parameters received from cancelation profile generator 130 into multiple parameters for programmable circuit 205 such that gain is adjusted. In yet other implementations, cancelation profile generator 130 may provide multiple values to cancelation profile effector 135 representing the energy of the noise in multiple frequency bands, and effector 135 translates the multiple values into one or more programmable circuit parameters for multiple programmable circuits 205, such that gain may be adjusted separately for multiple frequency bands.

In the example illustrated in FIG. 2, cancelation profile effector 135 may program value(s) into programmable circuit(s) 205 using the implemented programming protocol. Alternatively, cancelation profile effector 135 may send a notice to another component (not shown) to perform the programming of programmable circuit(s) 205.

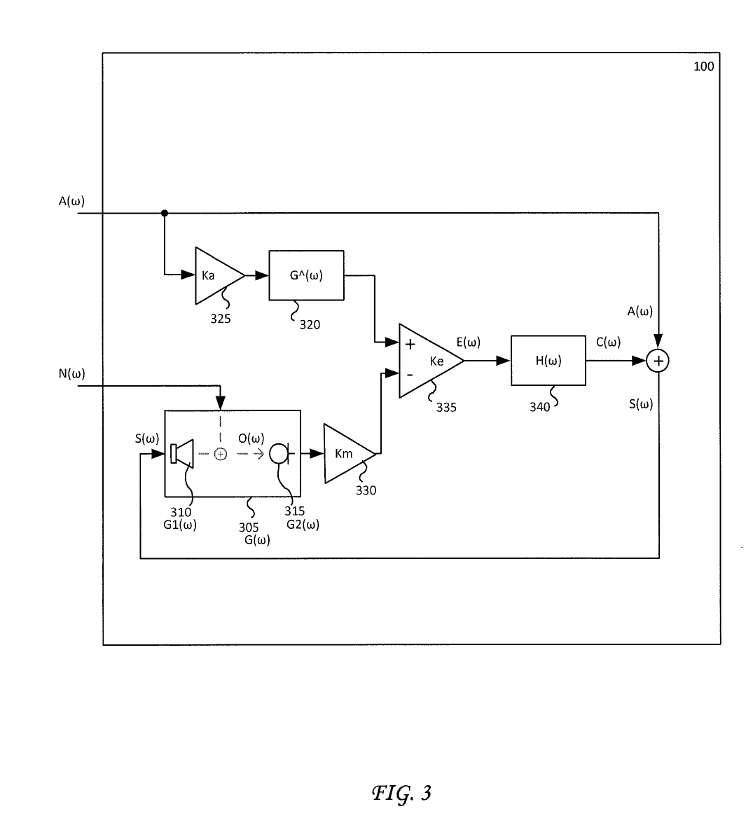

FIG. 3 illustrates an exemplary system model for a headphone with feedback to illustrate one representative active noise cancelation system. In the model, S(ω) represents an electrical input signal to a speaker in the ear cup of the headphone, A(ω) represents desirable audio components in the input signal S(ω), and N(ω) represents ambient acoustic noise that passes through the earphone to the ear canal. O(ω) represents all of the acoustic sound reaching the ear canal. C(ω) will be discussed below.

G(ω) represents the frequency response of an ear cup 305 of the headphone in which the speaker 310 receives input signal S(ω) and emits an acoustic signal. G1(ω) represents the frequency response of speaker 310. A microphone 315 provides an electrical signal as feedback representing a combination of the acoustic signal emitted by speaker 310 and noise N(ω). G2(ω) represents the frequency response of microphone 315. Km is the gain of an amplifier 330 for feedback microphone 315.

Ĝ(ω) represents the frequency response of an equalizer 320. Ka represents a gain in an audio amplifier 325. The combination of Ĝ(ω) and Ka is designed to have the same transfer function as the combination of G(ω) and Km.

Ke is a gain of an error amplifier 335 and E(ω) is an error signal at the output of error amplifier 335. Error signal E(ω) represents the acoustic signal received by microphone 315 with the desirable audio components A(ω) filtered out. Thus, in an ideal system, error signal E(ω) would be equal to zero.

H(ω) represents the frequency response of a compensation filter 340 and C(ω) is a compensatory signal at the output of compensation filter 340. H(ω) is designed to produce signal C(ω) such that speaker 310 in response to signal S(ω) emits an acoustic signal canceling noise N(ω) while allowing desirable audio to be delivered to the ear canal. Thus, in the ideal case, with noise N(ω) completely canceled and Ĝ(ω) and Ka perfectly matched to balance G(ω) and Km, the inputs to amplifier 335 are equal to each other and the error signal E(ω) at the output of amplifier 335 is zero.

Signal O(ω) is the sum of the acoustic signal emitted by speaker 310 and the noise N(ω). Signal O(ω) may be calculated as a function of A(ω), ignoring noise N(ω) for the moment, as illustrated in Equation (1).

O(ω)=(A(ω)+(A(ω)×Ka×Ĝ(ω)−O(ω)×Km×G(ω))×(Ke×H(ω)))×G1(ω) (1)

Solving Equation (1) for O(w) results in Equation (2), the component of O(w) related to the desired audio signal A(ω).

$$O ( ω ) = A ( ω ) \times G 1 ( ω ) \times \frac{1 + ( Ka \times Ke \times {G}^{⋀} ( ω ) \times H ( ω ) )}{1 + ( Km \times Ke \times G ( ω ) \times H ( ω ) )} \qquad ( 2 )$$

Equation (2) indicates that Ka x Ĝ(ω) should be equal to Km x G(ω), as noted above.

Signal O(ω) may also be calculated as an open-loop function of N(ω), ignoring audio signal A(ω), as illustrated in Equation (3).

O(ω)=N(ω)×Km×Ke×G(ω)×H(ω) (3)

Signal O(w) may be calculated as a closed-loop function of N(ω) also, resulting in the relationship shown in Equation (4).

$$O ( ω ) = N ( ω ) \times \frac{1}{1 + ( Km \times Ke \times G ( ω ) \times H ( ω ) )} \qquad ( 4 )$$

Equation (4) indicates that for good noise attenuation at the ear canal, the open loop response of O(w) as indicated in Equation (3) should be large.

A value for error amplifier 335 gain Ke may be calculated from the model of FIG. 3. For example, in Equation (4) it can be seen that gain Ke may be increased to compensate for an increase in the amplitude of noise N(ω). Gain Ke may be calculated by cancelation profile effector 135 in response to a value provided by cancelation profile generator 130 to compensate for noise described in a noise profile from noise energy profiler 125. Other parameters of components 320, 325, 330, 335, and 340 may also be changed to modify the response of the headphone.

In the example illustrated in FIG. 3 the components 320, 325, 330, 335, and 340 are shown as separate functions, and it was described, for example, that gain Ke of component 335 may be adjusted based on noise N(ω) amplitude. In other implementations, components 320, 325, 330, 335, and 340 may be implemented as one programmable circuit with one or more programmable values, and the circuit as programmed implements a transfer function as indicated by a profile generated by cancelation profile generator 130.

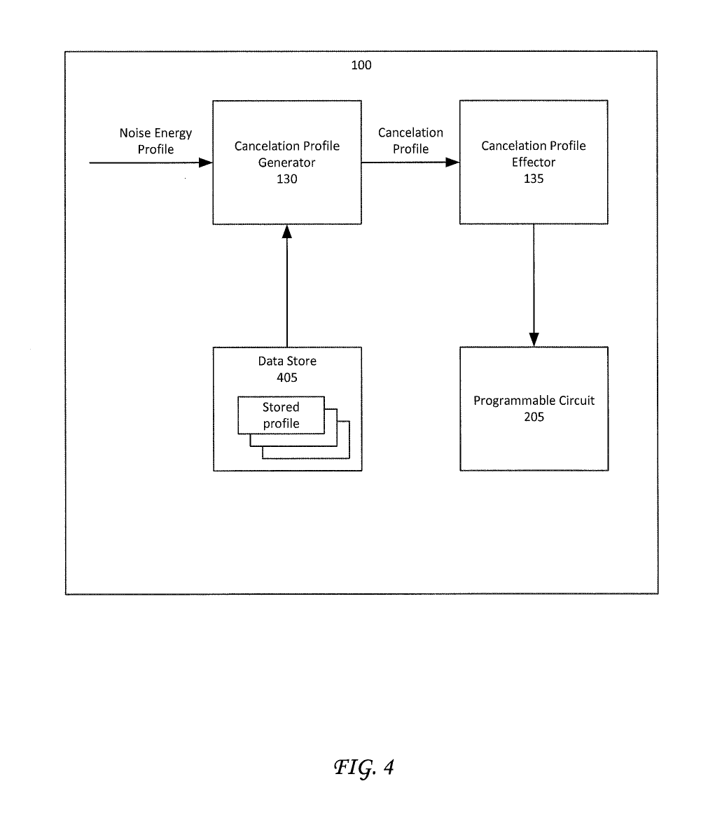

FIG. 4 illustrates a second representative exemplary cancelation profile generator 130 and associated cancelation profile effector 135, along with a programmable circuit 205 and a data store 405. Data store 405 may include various kinds of mechanisms for storing, accessing, and retrieving various kinds of data, including a hierarchical database, a set of files in a file system, an application database in a proprietary format, a relational database management system (RDBMS), etc.

In the implementation illustrated in FIG. 4, data store 405 includes a set of energy profiles and a set of predetermined cancelation profiles, where each cancelation profile corresponds to an energy profile. Cancelation profile generator 130 compares a noise energy profile from noise energy profiler 125 to the set of energy profiles in data store 405 and selects a nearest match. For example, if most of the noise energy is in the frequency band 400-500 Hz, then cancelation profile generator 130 may select an energy profile from data store 405 in which most of the energy is in the frequency band 400-500 Hz. Once a nearest match energy profile is selected, the corresponding cancelation profile is provided to the cancelation profile effector 135.

Continuing with the second representative example, cancelation profile effector 135 applies the cancelation profile to the system as appropriate for the system architecture. For example, in the headphone of FIG. 3, cancelation profile effector 135 may adjust parameters of compensation filter 340 by setting the parameters of one or more configurable circuits. As another example, in a headphone in which all of the components 320, 325, 330, 335, and 340 illustrated in FIG. 3 are implemented together in a programmable circuit, cancelation profile effector 135 may adjust the parameters of the circuit according to the profile to effect a system transfer function for canceling noise.

In the example illustrated in FIG. 4, cancelation profile effector 135 may program parameter(s) into programmable circuit(s) 205 using the implemented programming protocol. Alternatively, cancelation profile effector 135 may send a notice to another component (not shown) to perform the programming of programmable circuit(s) 205.

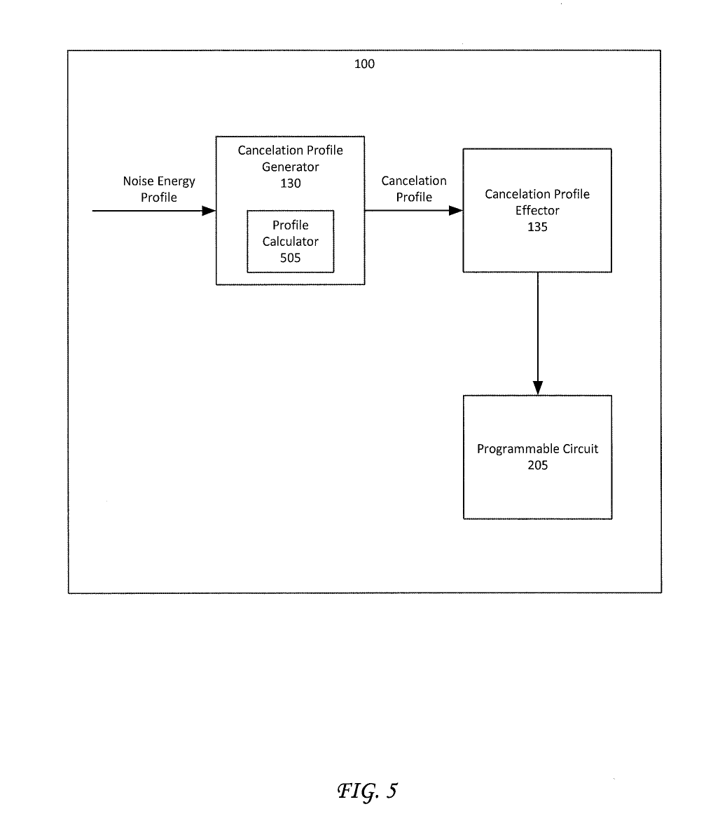

FIG. 5 illustrates a third representative exemplary cancelation profile generator 130 including profile calculator 505 and an associated cancelation profile effector 135, along with a programmable circuit 205. In this implementation, cancelation profile generator 130 calculates, using profile calculator 505, a cancelation profile that includes, for example, a desired cancelation signal for a compensation circuit or a desired transfer function for system 100 or a portion of system 100. Cancelation profile effector 135 may then translate the cancelation profile into information to adjust configurable circuits 205 of the compensation circuit or the system.

In the example illustrated in FIG. 5, cancelation profile effector 135 may program parameter(s) into programmable circuit(s) 205 using the implemented programming protocol. Alternatively, cancelation profile effector 135 may send a notice to another component (not shown) to perform the programming of programmable circuit(s) 205.

The exemplary implementations discussed above are not exhaustive, and many other implementations are possible.

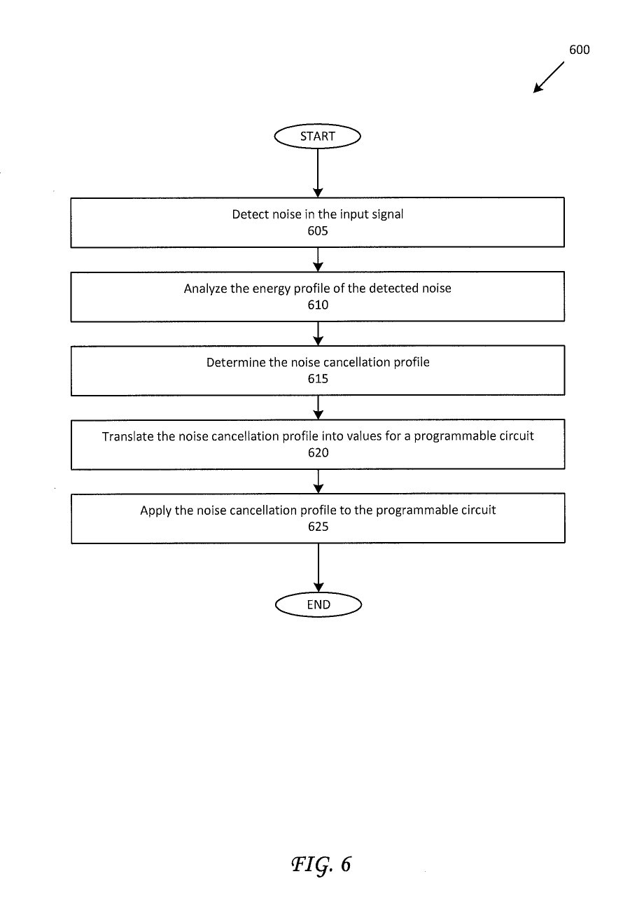

FIG. 6 illustrates an exemplary process 600 that may be implemented in a system 100. At block 605 noise detector 120 identifies noise within system 100. For example, noise detector 120 may be a set of bandpass filters and one or more circuits that measure the energy in several different frequency bands.

At block 610 noise energy profiler 125 analyzes the noise identified in block 605. For example, noise may be analyzed to identify a frequency band with the highest average energy, or a set of frequency bands may be identified that each has an energy peak above a threshold.

At block 615 cancelation profile generator 130 determines a noise cancellation profile. In some implementations, a noise cancellation profile may be a desired transfer function for system 100. In other implementations, a noise cancellation profile may be a desired transfer function for a programmable circuit such that a signal outputted by the programmable circuit is an anti-noise signal that cancels at least a portion of the noise identified at block 610.

At block 620 cancelation profile effector 135 translates the noise cancellation profile determined at block 615 into actual values to apply to a programmable circuit. For example, the noise cancellation profile may include cancelation in a certain frequency band and circuit values for a band pass filter may be calculated to achieve the desired cancelation in the desired band.

At block 625 the noise cancellation profile is applied to the programmable circuits by programming the values determined at block 620 into the programmable circuits according to the implemented programming protocol.

Following block 625, process 600 ends.

Thus, an electrical system is described that adapts to the environment by detecting undesirable signal components and configuring the system to compensate for the undesirable signal components. In the case in which the electrical system is a headphone, noise is detected, analyzed, and canceled.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. An apparatus, comprising:
a noise detector configured to identify undesirable noise components in an acoustic signal;
a noise energy profiler configured to analyze the identified undesirable noise components and generate a noise energy profile;
a cancelation profile generator configured to generate a noise cancelation profile based at least in part on information in the noise energy profile; and
a cancelation profile effector configured to translate the noise cancelation profile into values for a programmable circuit.

2. The apparatus of claim 1, the noise cancelation profile representing a desired gain for a feedback component of the apparatus, and the programmable circuit including at least one programmable element for adjusting the desired gain.

3. The apparatus of claim 1, further comprising a data store including a group of predefined energy profiles, the cancelation profile generator selecting a predefined energy profile from the group of predefined energy profiles based at least in part on the noise energy profile generated by the noise energy profiler.

4. The apparatus of claim 3, the data store further including a group of predefined cancelation profiles wherein each predefined energy profile corresponds to at least one cancelation profile, the cancelation profile generator further selecting a predefined cancelation profile corresponding to the selected predefined energy profile.

5. The apparatus of claim 4, the predefined cancelation profile representing a desired gain for a feedback component of the apparatus, and the programmable circuit including at least one programmable element for adjusting the desired gain.

6. The apparatus of claim 4, the predefined cancelation profile representing a desired frequency response for a signal path including the programmable circuit.

7. The apparatus of claim 4, the predefined cancelation profile representing a desired frequency response of an anti-noise signal generated by the programmable circuit.

8. The apparatus of claim 1, the cancelation profile generator including a profile calculator configured to calculate a cancelation profile.

9. The apparatus of claim 8, the calculated cancelation profile representing a desired frequency response for a signal path including the programmable circuit.

10. The apparatus of claim 8, the cancelation profile being substantially similar in amplitude and substantially opposite in phase to the noise energy profile across a predefined frequency spectrum, the calculated cancelation profile representing a desired frequency response of an anti-noise signal generated by the programmable circuit.

11. The apparatus of claim 1, included in a headphone.

12. The apparatus of claim 1, included in an auditory amplification device.

13. A method, comprising:
identifying undesirable noise components in an acoustic signal;
analyzing the identified undesirable noise components;
generating a noise energy profile;
generating a noise cancelation profile based at least in part on information in the noise energy profile; and
translating the noise cancelation profile into values for a programmable circuit.

14. The method of claim 13, the noise cancelation profile representing a desired gain for a feedback component of an apparatus, and the programmable circuit including at least one programmable element for adjusting the desired gain.

15. The method of claim 13, further comprising:
selecting a predefined energy profile from a group of predefined energy profiles in a data store based at least in part on the noise energy profile.

16. The method of claim 15, further comprising:
selecting a predefined cancelation profile from the data store, the predefined cancelation profile corresponding to the selected predefined energy profile.

17. The method of claim 16, the predefined cancelation profile representing a desired gain for a feedback component of an apparatus, and the programmable circuit including at least one programmable element for adjusting the desired gain.

18. The method of claim 16, the predefined cancelation profile representing a desired frequency response for a signal path including the programmable circuit.

19. The method of claim 4, the predefined cancelation profile representing a desired frequency response of an anti-noise signal generated by the programmable circuit.

20. The method of claim 13, the cancelation profile generator including a profile calculator configured to calculate a cancelation profile.

21. The method of claim 20, the calculated cancelation profile representing a desired frequency response for a signal path including the programmable circuit.

22. The method of claim 20, the cancelation profile being substantially similar in amplitude and substantially opposite in phase to the noise energy profile across a predefined frequency spectrum, the calculated cancelation profile representing a desired frequency response of an anti-noise signal generated by the programmable circuit.

23. The method of claim 13, included in a headphone.

24. The method of claim 13, included in an auditory amplification device.
